(19) United States
(12) Patent Application Publication
(10) Pub. No.: US 2025/0286431 A1
(43) Pub. Date: Sep. 11, 2025

(54) MAGNETIC LEVITATION DEVICE AND AN ELECTROMAGNETIC ROTARY DRIVE

(71) Applicant: Levitronix GmbH, Zürich (CH)

(72) Inventor: Daniel STEINERT, Bülach (CH)

(21) Appl. No.: 19/048,267

(22) Filed: Feb. 7, 2025

(30) Foreign Application Priority Data
Mar. 5, 2024 (EP) 24161381.9

(51) Int. Cl. H02K 7/09; H02K 1/12

(52) U.S. Cl. CPC H02K 7/09; H02K 1/12

(57) ABSTRACT

A magnetic levitation device includes a stator with a cup-shaped recess, which is arranged at an axial end of the stator and into which the rotor can be inserted. The stator has coil cores, each of which has a longitudinal leg and a pole piece. Each longitudinal leg extends from a first end in an axial direction to a second end, and a contact surface is arranged at the second end. Each pole piece extends from the contact surface in a radial direction to an end face. The radial direction is perpendicular to the axial direction, and the end faces are arranged around the cup-shaped recess. A concentrated winding is arranged at each longitudinal leg, and surrounds a respective longitudinal leg. Each pole piece is made of transverse sheet metal elements, and the transverse elements are stacked in the axial direction.

### CROSS REFERENCE TO RELATED APPLICATIONS

This Applicant claims priority to European Application Number EP 24161381.9 filed Mar. 5, 2024, the contents of which are herein incorporated by reference.

### BACKGROUND

### Technical Field

The disclosure relates to a magnetic levitation device and to an electromagnetic rotary drive with such a magnetic levitation device.

### Background Information

Magnetic bearing devices for contactless magnetic bearing of a rotor generally have the advantage that they do not require mechanical bearings for the rotor. The rotor is supported or stabilized by magnetic forces which are generated by a stator of the magnetic bearing device. Due to the absence of mechanical bearings, such magnetic bearing devices are in particular suitable for pumping, mixing, centrifuging or stirring devices, with which very sensitive substances are conveyed, for example blood pumps, or on which very high demands are made with respect to purity, for example in the pharmaceutical industry or in the biotechnological industry, or with which abrasive or aggressive substances are conveyed, which would very quickly destroy mechanical bearings, for example pumps or mixers for slurry, sulfuric acid, phosphoric acid or other chemicals in the semiconductor industry.

In the biotechnology industry, such magnetic bearing devices are used, for example, in connection with bioreactors, e.g. in centrifugal pumps for conveying the fluids into or out of the bioreactor, or in mixing devices which mix the fluids in the bioreactor. In the semiconductor industry, such magnetic bearing devices are not only used for conveying aggressive or abrasive substances, but also, for example, for rotation devices with which wafers are rotated.

It is also known to use magnetic bearing devices for viscometers.

### SUMMARY

It has been determined that the temple construction is an advantageous magnetic bearing device design, to which the present disclosure also relates.

The characteristic feature of the temple construction is that the stator of the magnetic bearing device has a plurality of coil cores, each of which comprises a longitudinal leg extending from a first end in an axial direction to a second end. Here, the axial direction refers to that direction which is defined by the desired axis of rotation of the rotor, which is supported by the magnetic bearing device. The desired axis of rotation is that axis of rotation about which the rotor rotates in the operating state when it is in a centered and non-tilted position with respect to the stator. Each coil core comprises, in addition to the longitudinal leg, a transverse leg, also called a pole piece, which is arranged in each case at the second end of the longitudinal leg, and which extends in the radial direction-usually towards inside-, wherein the radial direction is perpendicular to the axial direction. Thus, the transverse leg extends substantially at a right angle to the longitudinal leg. The coil cores each have the shape of an L, wherein the transverse legs form the short legs of the L. The rotor to be supported is then arranged between the transverse legs.

The plurality of the longitudinal legs which extend in the axial direction, and which are reminiscent of the columns of a temple has given this construction its name.

In one design, the stator of the magnetic bearing device has, for example, six coil cores which are arranged circularly and equidistantly around a cup-shaped recess into which the rotor can be inserted. The first ends of the longitudinal legs are usually connected in the circumferential direction by a back iron, which serves to conduct the magnetic flux. The rotor to be supported comprises a magnetically effective core, for example a permanent magnetic disk or a permanent magnetic ring, which is arranged between the radially inside located ends of the transverse legs, and which rotates about the axial direction in the operating state, wherein the rotor is magnetically supported without contact with respect to the stator.

For such magnetic bearing devices, it is not necessarily the case that the magnetically effective core of the rotor must be designed in a permanent magnetic manner. There are also known such designs in which the magnetically effective core of the rotor is designed in a permanent magnetic-free manner, i.e., without permanent magnets. Then, the magnetically effective core of the rotor is, for example, designed in a ferromagnetic manner and is made, for example, of iron, nickel-iron, cobalt-iron, silicon iron, mu-metal, or another ferromagnetic material.

Furthermore, designs are possible in which the magnetically effective core of the rotor comprises both ferromagnetic materials and permanent magnetic materials. For example, permanent magnets can be placed or inserted into a ferromagnetic base body. Such designs are advantageous, for example, if one wishes to reduce the costs of large rotors by saving permanent magnetic material.

The longitudinal legs carry windings to generate the electromagnetic fields necessary for the contactless magnetic bearing of the rotor. For example, the windings are designed such that one concentrated winding is wound around each longitudinal leg, i.e., the coil axis of each concentrated winding extends in each case in the axial direction. Here, it is typical for the temple construction that the coil axes of the concentrated windings run in the axial direction and that the concentrated windings are not arranged in the radial plane in which the rotor or the magnetically effective core of the rotor is supported in the operating state.

Designs are possible in which exactly one concentrated winding is arranged on each longitudinal leg. In other designs, several, for example exactly two, concentrated windings are provided on each longitudinal leg. Designs are also possible in which windings are provided that are wound around two longitudinal legs that are adjacent in the circumferential direction, so that these two adjacent longitudinal legs are both located in the interior space of the concentrated winding.

The coil cores of the magnetic bearing devices known from the state of the art are usually designed in sheet metal. This means that several sheet metals in the shape of the coil cores are stacked in circumferential direction, insulated from each other.

The sheet metal design of the coil cores prevents eddy currents for magnetic fields that run in the direction of the sheet metals, i.e. fields that follow the longitudinal leg in the axial direction and the transverse leg in the radial direction.

For magnetic fields that emerge laterally, i.e. in the circumferential direction, from the sheet metals of the longitudinal leg and the transverse leg, the insulation of the sheet metals is ineffective and thus eddy currents still occur, since these magnetic fields pass orthogonally through the sheet metals.

Particularly with magnetic bearing devices that have a large magnetic gap, wherein the magnetic gap is defined as the distance between the end face of the pole piece and the magnetically effective core of the rotor in the radial direction, orthogonal field components cannot be neglected and generate significant eddy current losses.

In the context of this application, a large magnetic gap means a magnetic gap that is greater than 1% of the diameter of the magnetically effective core in the radial direction. In some cases, the magnetic gap can be greater than or equal to 5% of the diameter of the magnetically effective core in the radial direction.

It is therefore an object of the disclosure to propose a magnetic levitation device for contactless magnetic levitation of a rotor with a disk-shaped or ring-shaped magnetically effective core, which magnetic levitation device has lower eddy current losses than the previous state of the art.

Furthermore, it is an object of the disclosure to propose an electromagnetic rotary drive with such a magnetic levitation device.

The subject matter of the disclosure meeting this object is characterized by the features disclosed herein.

According to the disclosure, a magnetic levitation device is thus proposed for contactless magnetic levitation of a rotor, which has a disk-shaped or ring-shaped magnetically effective core, wherein the magnetic levitation device has a stator with a cup-shaped recess, which is arranged at an axial end of the stator and into which the rotor can be inserted, wherein the stator has a plurality of coil cores, each of which has a longitudinal leg and a pole piece, wherein each longitudinal leg extends from a first end in an axial direction to a second end, wherein a contact surface is arranged at the second end, wherein each pole piece extends from the contact surface at least partially in a radial direction to an end face, wherein the radial direction is perpendicular to the axial direction, wherein the end faces are arranged around the cup-shaped recess, wherein at least one concentrated winding is arranged at each longitudinal leg, which surrounds the respective longitudinal leg, wherein each pole piece is made of transverse elements in sheet metal, and wherein the transverse elements are stacked in the axial direction.

Most eddy current losses occur at the pole pieces, since the distance between adjacent pole pieces is particularly small, in particular at their ends facing the cup-shaped recess. The reason for this is that the eddy current losses mainly result from orthogonal fields, i.e. fields that penetrate the transverse elements orthogonally. Such orthogonal fields have the possibility of flowing in the circumferential direction from the pole piece of a first coil core to the pole piece of a second, adjacent coil core, in particular with small distances between the pole pieces. Due to the transverse elements of the pole piece stacked in the axial direction, orthogonal fields in the circumferential direction are prevented. This results in the fact that the eddy current losses are drastically reduced.

This results in another important advantage. The end faces of the pole pieces can be arranged much closer together in the circumferential direction because fields that flow in the circumferential direction from the pole piece of a first coil core to the pole piece of a second, adjacent coil core flow parallel to the transverse elements stacked in the axial direction and thus do not generate any eddy current losses. In this way, for example, the passive rigidity and the active levitation forces can be improved and/or a more compact construction of the stator is possible.

The attachment of a pole piece to a longitudinal leg can be carried out using several possible joining methods. Inter alia, these include a force-locking joining method, such as clamping or crimping, a form-locking joining method, such as screwing or plugging, or a material-locking connection, such as gluing. It is also possible to make the connection between the longitudinal leg and the pole piece via tongue and groove joints and/or bungs, such as pins, tines or dovetail joints. In a preferred embodiment, the material-locking joining method is realized by gluing.

According to a preferred embodiment, each longitudinal leg is made of longitudinal elements in sheet metal, wherein the longitudinal elements are stacked in the circumferential direction of the stator.

According to a preferred embodiment, the transverse elements and/or the longitudinal elements are made of electrical sheet metal.

According to the general definition, an electrical sheet metal is understood to be a soft magnetic material for magnetic cores. Materials which have a low coercive field strength are usually called soft magnetic materials. The coercive field strength is that magnetic field strength which is required to demagnetize a material. Within the framework of this application, a soft magnetic material is understood to be a material, which has a coercive field strength, more precisely a coercive field strength of the magnetic polarization, which amounts to less than 2'000 A/m.

There also exists the possibility of using mu-metal for the transverse element and/or the longitudinal element.

According to a preferred embodiment, the contact surface is designed in a planar manner and is arranged at a surface of the longitudinal leg which stands perpendicular on the radial direction. In this case, the contact surface is particularly preferably arranged at the second end of the longitudinal leg.

According to a preferred embodiment, the end face of the pole piece is designed as a curved surface. It is particularly preferred that the end face is designed and arranged coaxially to the cup-shaped recess. In other words, the end face of the pole piece is a segment of a cylinder surface, wherein the central axis of this cylinder coincides with the central axis of the cup-shaped recess and its radius is larger than that of the cup-shaped recess, so that the end face does not protrude into the cup-shaped recess.

Furthermore, it is preferred that the end face is designed to be wider with respect to the circumferential direction than the maximum extension of the contact surface in the circumferential direction. This means that one of the two edges of the end face, which extend in the circumferential direction, is longer than one of the edges of the contact surface, which extend in the circumferential direction. If the end face is designed as a curved surface, the length of one of the circular arcs of the segment of the cylinder surface in the radial plane is greater than the length of one of the edges of the contact surface which extend in the circumferential direction.

This widening of the end face in the circumferential direction has the advantage that the magnetic functionality is favored. For example, the passive rigidity and the active levitation forces can be improved.

A further advantage arises in combination with the embodiment of the pole pieces with transverse elements. The end faces can be made significantly wider with respect to the circumferential direction, i.e. their extension in the circumferential direction can be significantly larger than the end faces of coil cores known from the state of the art. Conversely, the distance between two end faces of two adjacent coil cores can be significantly reduced. The reason for this is that the fields emerging laterally from the pole piece flow parallel to the transverse elements stacked in the axial direction, and thus no additional eddy currents are generated.

According to a preferred embodiment, the end face has at least one slot which extends in the axial direction. In other words, this means that the at least one slot can extend in the end face in the axial direction in any length.

According to a preferred embodiment, the at least one slot extends from an axially first end of the pole piece to an axially second end of the pole piece. Thus, this extension would be the maximum possible extension of a slot in the end face in the axial direction.

For a possible embodiment in which the end face has more than one slot, it is possible that one slot extends from a first end of the pole piece in the axial direction and a second slot extends from the axially second end of the pole piece to the first slot in the opposite axial direction. In this case, it is possible that the two slots each have an extension in the axial direction that is less than 50% of the extension of the end face in the axial direction. In other words, this means that the end face has two slots that do not touch in the middle of the end face and thus there is at least one transverse element of the pole piece that is not captured by the slot.

The provision of at least one slot in the end face of the coil core provides an electrical insulation. This means that the at least one slot ensures that the path of the eddy currents in the transverse elements of the pole piece is interrupted and thus blocked. Thus, eddy currents resulting from magnetic fields emerging from the transverse elements in the axial direction can be prevented. As a result, only small eddy currents remain in the coil core and the eddy current losses in the coil core are drastically reduced overall. Here, it is advantageous that the at least one slot should run parallel or at least approximately parallel to the course of the magnetic field in the transverse element of the pole piece so as not to block it.

A number of different methods can be used to produce the slots. Inter alia, these include mechanical processes such as milling, punching or cutting, whereby the latter also includes the use of lasers and/or water jet cutters and/or wire erosion.

Furthermore, it is preferred that an extension of the at least one slot in the radial direction is smaller than the extension of the pole piece in the radial direction. In preferred embodiments, the extension of the at least one slot in the radial direction is in the area of 5-30% of the extension of the pole piece in the radial direction. It is also possible that the extension has more than 30%, e.g. 40% or 50% or even 99% of the extension of the pole piece. Larger extensions of the at least one slot in the radial direction are possible, especially in designs in which the at least one slot does not extend through all the transverse elements of the pole piece. In this case, it is even conceivable that 100% is achieved.

According to a preferred embodiment, several slots are arranged parallel or at least approximately parallel to each other in the end face. In advantageous embodiments, the several slots are arranged perpendicular to the end face.

The arrangement of the several slots parallel to each other is advantageous because this means that they also run parallel or at least approximately parallel to the course of the magnetic field in the coil core, so that they do not block it.

According to a preferred embodiment, each coil core has a rounding off at an axially upper end, which redirects the coil core from the axial direction to the radial direction.

For example, in the case of an L-shaped coil core, wherein the long part of the “L” is formed by the longitudinal leg and the short part of the “L” is formed by the pole piece, the radially outside located edge of the pole piece, when viewed from the cup-shaped recess, which extends in the radial plane in the circumferential direction is designed in a rounded manner. This embodiment has the advantage that it has lower eddy current losses and is also easier to realize with regard to construction. This embodiment can be realized with all possible embodiments the end face and the pole pieces or longitudinal legs.

According to a preferred embodiment, each coil core has a first lateral boundary surface and a second lateral boundary surface, wherein at least one of the first or the second lateral boundary surfaces has at least one slot. The provision of slots in at least one of the two lateral boundary surfaces of the coil core provides an electrical insulation. This means that the at least one slot ensures that the path of the eddy currents in the coil core is interrupted and thus blocked. As a result, only small eddy currents remain in the coil core and the eddy current losses in the coil core are drastically reduced overall. In this case it is advantageous that the at least one slot should run parallel or at least approximately parallel to the course of the magnetic field in the coil core so as not to block it.

It is variable how far the at least one slot extends in the longitudinal leg in axial direction in the direction of the first end of the longitudinal leg. From a small extension of 5% of the total length of the longitudinal leg in axial direction to an extension towards the first end of the longitudinal leg, all lengths of the at least one slot are possible.

It is also possible that the at least one slot has a rounding which redirects the slot from the radial direction to the axial direction.

Embodiments are also possible in which the at least one slot extends from the first lateral boundary surface to the second lateral boundary surface.

In other embodiments it is possible that the extension of the at least one slot is shorter than the distance of the first lateral boundary surface from the second lateral boundary surface when viewed in the circumferential direction of the stator.

In other words, the at least one slot does not extend through the entire coil core in the circumferential direction of the stator. This means that the at least one slot is not provided in all longitudinal elements of the sheet metal design of the coil core. This is advantageous because the majority of the eddy currents occur especially in the longitudinal elements that are arranged directly or close to the two lateral boundary surfaces. Thus, the paths of the eddy currents in the coil core are interrupted by the at least one slot where they occur most frequently. This ensures a significant reduction in eddy current losses. Furthermore, this embodiment is advantageous for the stability of the coil core.

Embodiments are also possible in which several slots are provided which are arranged parallel to each other. Here, the arrangement of the several slots parallel to each other is advantageous, as they thus also run parallel or at least approximately parallel to the course of the magnetic field in the coil core, so that they do not block it.

A number of different methods can be used to produce the slots. Inter alia, these include mechanical processes such as milling, punching or cutting, whereby the latter also includes the use of lasers or water jet cutters.

According to a particularly preferred embodiment, a back iron is arranged at the first end, which connects the first ends of all longitudinal legs, wherein the back iron is designed in a ring-shaped manner with a metallic strip which extends from a radially inner beginning to a radially outer end, wherein the strip forms several strip windings which lie flat against one another with respect to the radial direction.

According to a particularly preferred embodiment, the stator of the magnetic levitation device is designed for generating a torque with which the rotor can be magnetically driven without contact for rotation about the axial direction.

Here, the stator is designed as a bearing and drive stator, which is both the stator of the electric drive and the stator of the magnetic levitation. The electric windings of the stator can be used to generate a magnetic rotating field, which on the one hand exerts a torque on the rotor, which causes its rotation about a desired axis of rotation, and which, on the other hand, exerts an arbitrarily adjustable transverse force on the rotor, so that its radial position can be actively controlled or regulated.

Particularly with regard to the embodiment in which the magnetic levitation device is designed to generate a torque, the embodiment with the wider end face is advantageous, as the magnetic functionality is favored in this way. For example, an increased torque can be generated, or the passive rigidity or the active levitation forces can be improved.

Furthermore, an electromagnetic rotary drive which is designed as a temple motor is proposed by the disclosure wherein the electromagnetic rotary drive comprises a magnetic levitation device according to the disclosure as well as a rotor with a disk-shaped or ring-shaped magnetically effective core, wherein the rotor can be inserted into the cup-shaped recess, and wherein the rotor is designed as the rotor of the electromagnetic rotary drive.

Such electromagnetic rotary drives are also known as bearingless motors. The term bearingless motor refers to an electromagnetic rotary drive in which the rotor is levitated completely magnetically with respect to the stator, wherein no separate magnetic bearings are provided.

Further advantageous measures and embodiments of the disclosure are apparent from the dependent claims.

### BRIEF DESCRIPTION OF THE DRAWINGS

In the following, the disclosure will be explained in more detail with reference to embodiments and with reference to the drawing. In the drawing show:

FIG. 1 is a perspective view of a first embodiment of a magnetic levitation device according to the disclosure,

FIG. 2 is a perspective view of a single coil core of the magnetic levitation device from FIG. 1.

FIG. 3 is a perspective view of a first variant of a coil core from FIG. 2,

FIG. 4 is an enlarged view of the pole piece of the coil core from FIG. 3,

FIG. 5 is a perspective view of a second variant of a coil core from FIG. 2,

FIG. 6 is a perspective view of a second embodiment of a magnetic levitation device according to the disclosure,

FIG. 7 is a perspective view of a single coil core of the magnetic levitation device from FIG. 6,

FIG. 8 is a perspective view of a third embodiment of a magnetic levitation device according to the disclosure, and

FIG. 9 is a schematic sectional view for an embodiment of a stator housing.

### DETAILED DESCRIPTION

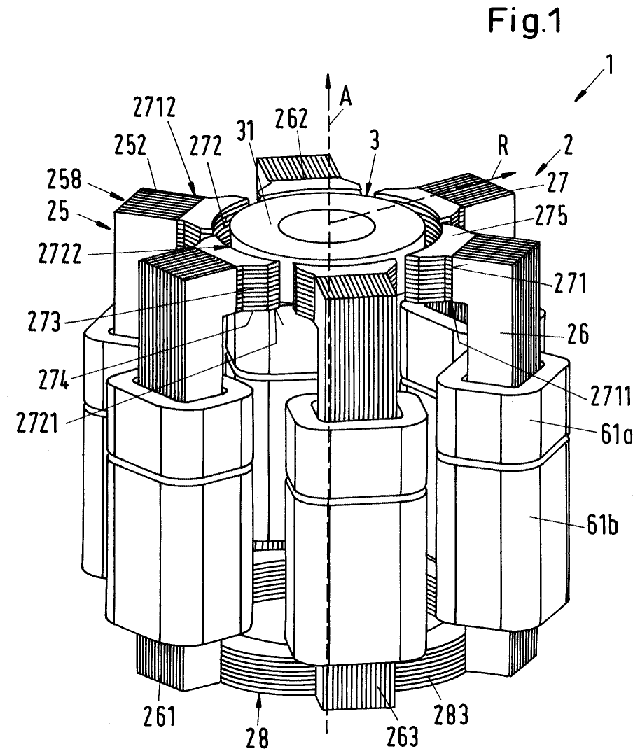

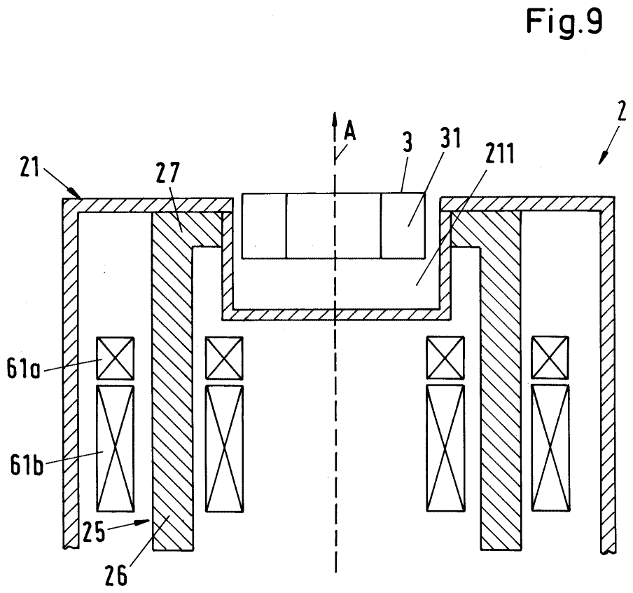

FIG. 1 shows a perspective view of an embodiment of a magnetic levitation device according to the disclosure, which is designated in its entirety by the reference sign 1. The magnetic levitation device 1 is designed for the contactless magnetic levitation of a rotor 3, which comprises a disk-shaped or ring-shaped magnetically effective core 31. The magnetic levitation device 1 is designed according to the temple construction and comprises a stator 2. Normally, the stator 2 comprises a stator housing 21 (FIG. 9), which is, however, not represented in FIG. 1 for reasons of a better overview. In a schematic sectional view, FIG. 9 therefore illustrates an embodiment of a stator housing 21.

A cup-shaped recess 211 is provided on one axial end of the stator housing 21 into which the rotor 3 can be inserted. The rotor 3 is designed for rotation about a desired axis of rotation. This desired axis of rotation defines an axial direction A. Normally, the central axis of the stator 2, which extends in the axial direction A, coincides with the desired axis of rotation. The desired axis of rotation designates that axis about which the rotor 3 rotates in the operating state when the rotor 3 is in a centered and non-tilted position with respect to the stator 2, as represented in FIG. 1.

The stator 2 has a plurality of coil cores 25—here six coil cores 25—each of which has a longitudinal leg 26 and a pole piece 27. Each longitudinal leg 26 extends from a first end 261 in axial direction A to a second end 262, wherein a contact surface 271 is arranged at the second end 262, from which each pole piece 27 extends at least partially in a radial direction R to an end face 272. Here, the end faces 272 face the rotor 3 and are arranged around it. In other words, the pole pieces 27 of the coil cores 25 are arranged in such a way that the end faces 272 of the pole pieces 27 are arranged around the cup-shaped recess 211. The coil cores 25 of the stator 2 are arranged equidistantly on a circular line, so that the end faces 272 surround the magnetically effective core 31 of the rotor 3 when the rotor 3 is inserted into the cup-shaped recess 211.

In this embodiment, the contact surface 271 is designed in a planar manner and is arranged at a surface of the longitudinal leg 26 which stands perpendicular on the radial direction R.

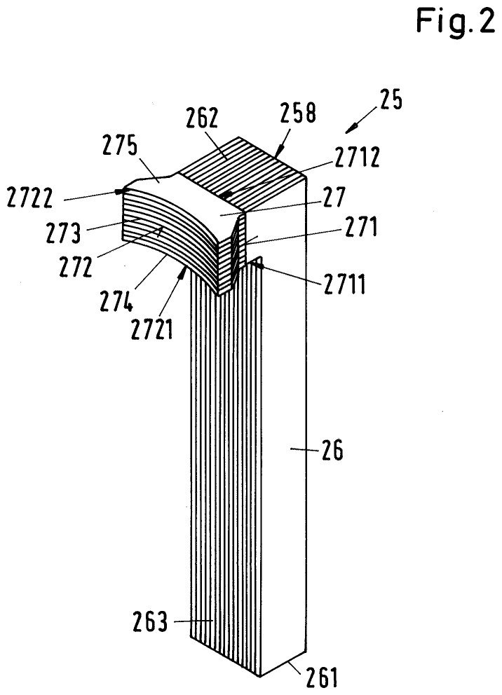

For better understanding, a perspective view of a single coil core 25 of the magnetic bearing device 1 from FIG. 1 is represented in FIG. 2.

At least one concentrated winding 61 is arranged at each longitudinal leg 26, which surrounds the respective longitudinal leg 26. In other embodiments, more than one concentrated winding can also be arranged at the longitudinal legs 26. For example, there are embodiments, as represented here in FIG. 1, in which exactly two concentrated windings 61a, 61b are provided in each case on each of the longitudinal legs 26, each of which surrounds the respective longitudinal leg 26, wherein the two windings 61a, 61b arranged on the same longitudinal leg 26 are arranged adjacent to each other with respect to the axial direction A.

The concentrated windings 61 serve to generate electromagnetic fields with which the rotor 3 can be magnetically levitated without contact in the cup-shaped recess 211 (FIG. 9).

In the first embodiment of the magnetic levitation device 1 according to the disclosure represented in FIG. 1, the pole pieces 27 are made of transverse elements 273 in sheet metal and these transverse elements 273 are stacked in the axial direction A.

Due to the transverse elements 273 of the pole piece 27 stacked in the axial direction, fields flowing in the circumferential direction are conducted parallel to the sheet metal plane. In this way, the eddy current losses are drastically reduced.

This results in another important advantage. The end faces 272 of the pole pieces 27 can be arranged much closer to one another in the circumferential direction, since fields flowing in the circumferential direction from the pole piece 27 of a first coil core 25 to the pole piece 27 of a second, adjacent coil core 25 do not generate any additional eddy current losses. Thus, for example, the passive rigidity and the active levitation forces can be improved and/or a more compact design of the stator is possible. The attachment of a pole piece 27 to a longitudinal leg 26 can be carried out using several possible joining methods. Inter alia, these include a force-locking joining method, such as clamping or crimping, a form-locking joining method, such as screwing or plugging, or a material-locking connection, such as gluing. It is also possible to make the connection between the longitudinal leg 26 and the pole piece 27 via tongue and groove joints and/or bungs, such as pins, tines or dovetail joints. In a preferred embodiment, the material-locking joining method is realized by gluing.

Here, the end faces 272 of the pole pieces 27 are designed as curved surfaces, which are arranged coaxially to the cup-shaped recess 211. In this case, the end face 272 is designed to be wider with respect to the circumferential direction than the maximum extension of the contact surface 271 in the circumferential direction. The circumferential direction refers to that direction which stands perpendicular on the radial direction R and perpendicular on the axial direction A.

Thus, the end face 272 of the pole piece 27 can be regarded as a segment of a cylinder surface, wherein the central axis of this cylinder coincides with the central axis of the cup-shaped recess 211, in this embodiment the axis of the axial direction A, and whose radius is greater than that of the cup-shaped recess 211, so that the end face 272 does not protrude into the cup-shaped recess 211.

This means in other words that one of the two edges 2721 or 2722 of the end face 272, which extend in the circumferential direction, is longer than one of the edges 2711 or 2712 of the contact surface, which extend in the circumferential direction. If the end face 272 is designed as a curved surface, the length of one of the circular arcs 2721 or 2722 of the segment of the cylinder surface in a radial plane is greater than the length of one of the edges 2711 or 2712 of the contact surface 271, which extend in the circumferential direction. The radial plane is indicated in FIG. 1 by the line of a radial direction R, which stands perpendicular on the axial direction A. The radial plane is that plane which stands perpendicular on the axial direction A and contains a radial direction R. The radial plane is that plane in which the magnetically effective core 31 of the rotor 3 is actively magnetically levitated between the end faces 272 in the stator 2 in the operating state. If the rotor 3 is not tilted and is not deflected in the axial direction A, the magnetic center plane lies in the radial plane. The radial plane defines the x-y plane of a Cartesian coordinate system whose z-axis runs in the axial direction A.

The radial position of the magnetically effective core 31 or the rotor 3 refers to the position of the rotor 3 in the radial plane.

In this embodiment, the longitudinal leg 26 is also made of longitudinal elements 263 in sheet metal, wherein the longitudinal elements 263 are stacked in the circumferential direction of the stator 2.

The longitudinal elements 263 and the transverse elements 273 can be made of electrical sheet metal. According to the general definition, an electrical sheet metal is understood to be a soft magnetic material for magnetic cores. There also exists the possibility of using mu-metal for the strip.

The number of the longitudinal elements 263 and the transverse elements 273 in all embodiments and figures is to be understood as purely exemplary. The number can be larger or even smaller than represented.

According to a particularly preferred embodiment, the stator 2 is designed in such a way that, in addition to the contactless magnetic levitation of the rotor 3, it can also exert a torque on the rotor 3 or the magnetically effective core 31 of the rotor 3, which drives the rotor 3 to rotate about the desired axis of rotation. This means that in this preferred embodiment, the rotor 3 can be driven for rotation about the axial direction A.

The already mentioned widening of the end face 272 in the circumferential direction has the advantage that the magnetic functionality is favored in this way. For example, the passive rigidity and the active levitation forces can be improved. With regard to the embodiment in which the magnetic levitation device 1 is designed to generate a torque, there is also the advantage that an increased torque can be generated.

In this embodiment, the concentrated windings 61a, 61b thus generate electromagnetic rotating fields with which the rotor 3 can be both magnetically levitated without contact with respect to the stator 2 and can also be driven without contact for rotation about the axial direction A.

It is understood that the number of six coil cores 25, although preferred, is only to be understood as an example. Of course, such embodiments are also possible in which the stator 2 has fewer than six, e.g. five or four or three coil cores 25, or such embodiments in which the stator 2 has more than six, e.g. seven or eight or nine coil cores 25 or any larger number of coil cores 25.

The rotor 3 comprises the magnetically effective core 31, which is designed in a ring-shaped or disk-shaped manner. According to the representation in FIG. 1, the magnetically effective core 31 is designed as a ring and defines a magnetic center plane. Alternatively, the magnetically effective core 31 can also be designed as a disk. Normally, in the case of a disk-shaped or ring-shaped magnetically effective core 31, the magnetic center plane is the geometric center plane of the magnetically effective core 31 of the rotor 3, which is perpendicular to the axial direction A. In the operating state, the magnetically effective core 31 is levitated in a radial plane, which stands perpendicular on the axial direction A.

Since it is sufficient for the understanding of the disclosure, only the magnetically effective core 31 of the rotor 3 is represented in FIG. 1. It is understood that the rotor 3 can of course also comprise further components such as jackets or encapsulations, which are preferably made of a plastic, or of a metal or of a metal alloy or of a ceramic or a ceramic material. Furthermore, the rotor 3 can also comprise vanes for mixing, stirring or pumping fluids or other components.

When the rotor 3 is inserted into the cup-shaped recess 211 (FIG. 9), the rotor 3 and in particular the magnetically effective core 31 of the rotor 3 is surrounded by the radially outwardly arranged end faces 272 of the pole piece 27 of the coil cores 25 of the stator 2. Thus, the pole pieces 27 form a plurality of pronounced stator poles—in this case six stator poles.

When the magnetically effective core 31 of the rotor 3 is in its desired position during operation, the magnetically effective core 31 is centered between the end faces 272 of the pole pieces 27. According to the representation, the concentrated windings 61 are arranged below the radial plane and are aligned such that their coil axes extend in axial direction A.

All first ends 261 of the longitudinal legs 26—i.e., the lower ends 261 according to the representation (FIG. 1)—are connected to each other by a back iron 28. The back iron 28 is preferably designed in a ring-shaped manner. Such embodiments are possible (see FIG. 1, for example) in which the back iron 28 extends radially inwardly along all first ends 261 of the longitudinal legs 26.

In order to generate the electromagnetic fields required for the magnetic levitation of the rotor 3 and optionally for the generation of a torque on the rotor 3, the longitudinal legs 26 of the coil cores 25 carry the windings designed as concentrated windings 61.

In the operating state, those electromagnetic rotating fields are generated with these concentrated windings 61 with which an arbitrarily adjustable transverse force in the radial direction can be exerted on the rotor 3, so that the radial position of the rotor 3, i.e. its position in the radial plane perpendicular to the axial direction A, can be actively controlled or regulated. Optionally, a torque is additionally effected on the rotor 3 with these electromagnetic rotating fields.

The “magnetically effective core 31” of the rotor 3 refers to that region of the rotor 3 which magnetically cooperates with the stator 2 for the generation of magnetic levitation forces and optionally for torque generation.

As already mentioned, the magnetically effective core 31 is designed in a ring-shaped manner in this embodiment. Furthermore, the magnetically effective core 31 is designed in a permanent magnetic manner. For this purpose, the magnetically effective core 31 can comprise at least one permanent magnet, but also several permanent magnets, or-as in the embodiment described here—consist entirely of a permanent magnetic material, so that the magnetically effective core 31 is the permanent magnet. For example, the magnetically effective core 31 is magnetized in the radial direction.

Those ferromagnetic or ferrimagnetic materials, which are magnetically hard, that is which have a high coercive field strength, are typically called permanent magnets. The coercive field strength is that magnetic field strength which is required to demagnetize a material. Within the framework of this application, a permanent magnet is understood as a component or a material, which has a coercive field strength, more precisely a coercive field strength of the magnetic polarization, which amounts to more than 10'000 A/m.

Such embodiments are also possible in which the magnetically effective core 31 is designed in a permanent magnet-free manner, i.e., without permanent magnets. The rotor 3 is then designed, for example, as a reluctance rotor. Then, the magnetically effective core 31 of the rotor 3 is made of a soft magnetic material, for example. Suitable soft magnetic materials for the magnetically effective core 31 are, for example, ferromagnetic or ferrimagnetic materials, i.e., in particular iron, nickel-iron, cobalt-iron, silicon iron, mu-metal.

Furthermore, embodiments are possible in which the magnetically effective core 31 of the rotor 3 comprises both ferromagnetic materials and permanent magnetic materials. For example, permanent magnets can be placed or inserted into a ferromagnetic base body. Such embodiments are advantageous, for example, if one wishes to reduce the costs of large rotors by saving permanent magnetic material.

Embodiments are also possible in which the rotor is designed according to the principle of a cage rotor.

The stator 2 is free of permanent magnets. Within the framework of this application, the term that the stator 2 is designed “free of permanent magnets” is to be understood to mean that the stator 2 does not comprise any permanent magnets that contribute substantially to the drive field for driving the rotation of the rotor 3 or for generating the magnetic levitation forces for the rotor 3. Thus, the magnetic flux generated by the stator 2 for the drive and the levitation the rotor 3 does not comprise any permanent-magnetically excited flux.

Of course, it is possible that the rotor 3 and/or the stator 2 comprise other magnets or permanent magnets, for example in sensors that serve, for example, to capture the angular position of the rotor, or that otherwise fulfill a purpose that has nothing to do with generating the magnetic flux for the drive and the levitation of the rotor 3.

Thus, the term “free of permanent magnets” refers only to the generation of the magnetic flux for the drive and the levitation of the rotor 3 by the stator 2. In other words, the stator 2 has no permanent magnets that contribute to the magnetic flux by which the rotor 3 is driven and magnetically levitated.

However, it is still possible that the magnetic flux for the drive and the levitation of the rotor 3 comprises a permanent magnetic flux, but this is then only generated by the rotor 3 itself. This would be the case if the rotor 3 itself were to comprise a permanent magnet.

The ring-shaped back iron 28 can be made of a soft magnetic material as this is well suited for conducting the magnetic flux. It is also possible that the coil cores 25 of the stator 2 are also made of a soft magnetic material.

Suitable soft magnetic materials for the coil cores 25 and the back iron 28 are, for example, ferromagnetic or ferrimagnetic materials, i.e., in particular iron, nickel-iron, cobalt-iron, silicon-iron or mu-metal. In this case, for the stator 2, a design as a stator sheet metal stack is preferred, in which the back iron 28 is designed in sheet metal, i.e., it consists of several thin sheet metal elements, also called back iron elements 283, which are stacked parallel to each other in the axial direction A. All back iron elements 283 are identically designed, i.e., in this case substantially ring-shaped and also with the same thickness in each case. Thus, the back iron 28 itself is substantially designed in a ring-shaped manner and extends radially inwardly along the first ends 261 of the longitudinal legs 26 in the assembled state.

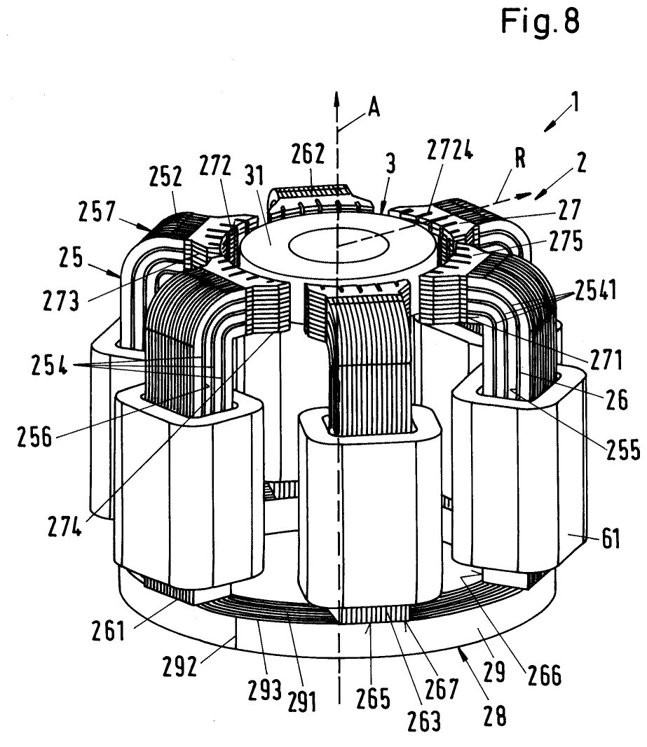

Embodiments in which a so-called tape wound toroidal core is used as the back iron 28 are also possible. This is a coiled strip 29. Such a design is realized in the third embodiment, which is represented in FIG. 8.

Furthermore, it is possible that the back iron 28 consists of pressed and subsequently sintered grains of the aforementioned materials. The metallic grains are preferably embedded in a plastic matrix so that they are at least partially insulated from each other, whereby eddy current losses can be minimized. Thus, soft magnetic composites, which consist of electrically insulated and compressed metal particles are also suitable for the stator. In particular, these soft magnetic composites, which are also designated as SMC (Soft Magnetic Composites), can consist of iron powder particles which are coated with an electrically insulating layer. These SMC are then formed into the desired shape by powder metallurgy processes.

During operation of the magnetic levitation device 1, the magnetically effective core 31 of the rotor 3 cooperates with the stator 2 in such a way that the rotor 3 can be magnetically levitated without contact with respect to the stator 2 and preferably can also be magnetically set in rotation without contact about the axial direction A. In this case, it is particularly advantageous that the same windings 61, with which the magnetic levitation of the rotor 3 is effected, also serve to generate a torque on the rotor 3. Preferably, three degrees of freedom of the rotor 3 can then be actively regulated, namely its position in the radial plane and its rotation. With respect to its axial deflection from the radial plane in axial direction A, the magnetically effective core 31 of the rotor 3 is passively magnetically stabilized by reluctance forces, i.e., it cannot be controlled. The magnetically effective core 31 of the rotor 3 is also passively magnetically stabilized with respect to the remaining two degrees of freedom, namely tilting with respect to the radial plane perpendicular to the desired axis of rotation. By the cooperation of the magnetically effective core 31 with the coil cores 25, the rotor 3 is thus passively magnetically levitated or passively magnetically stabilized in the axial direction A and against tilting (a total of three degrees of freedom) and actively magnetically levitated in the radial plane (two degrees of freedom).

As is generally the case, an active magnetic levitation is also referred to in the framework of this application as one which can be actively controlled or regulated, for example by the electromagnetic fields generated by the concentrated windings 61. A passive magnetic levitation or a passive magnetic stabilization is one that cannot be controlled or regulated. The passive magnetic levitation or stabilization is based, for example, on reluctance forces, which bring the rotor 3 back again to its desired position when it is deflected from its desired position, i.e., for example, when it is displaced or deflected in axial direction A or when it is tilted.

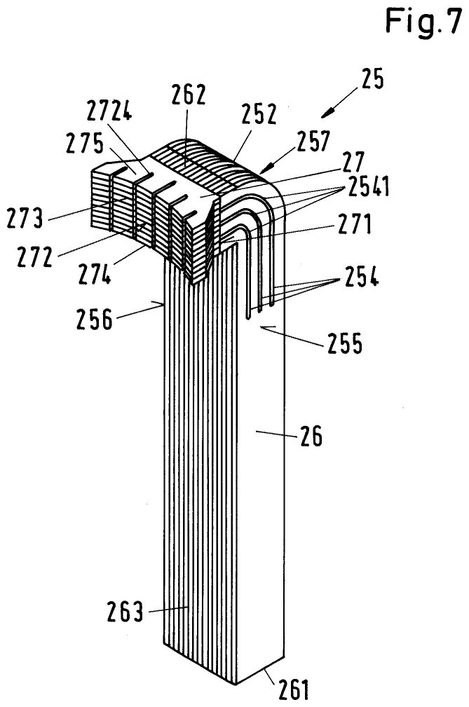

In the magnetic levitation device 1, in contrast to classic magnetic bearings, the magnetic levitation—and optionally the generation of a torque acting on the rotor—is realized by electromagnetic rotating fields. For the combined generation of the magnetic levitation forces and a torque for rotating the rotor 3 about the axial direction A, it is possible on the one hand—as shown in FIG. 7—to arrange exactly one concentrated winding 61 at each longitudinal leg 26.

On the other hand, embodiments are also possible in which two different winding systems are provided for the combined generation of the magnetic levitation forces and a torque for rotating the rotor 3. For this purpose, for example, exactly two concentrated windings 61a, 61b are arranged in each case at each longitudinal leg, as represented in FIG. 1, which are arranged adjacent to each other with respect to the axial direction A. One of these two windings 61a, 61b belongs to the first of the two winding systems and the other to the second of the two winding systems.

In the embodiment represented in FIG. 8 with exactly one concentrated winding 61 at each coil core 25, for example the values for the current required for the levitation and the current required for the generation of the torque determined in each case in a control unit are added or superimposed by calculation—e.g., with the aid of software. Then, the resulting total current is impressed into the respective concentrated winding 61.

If the stator 2 of the magnetic levitation device 1 according to the disclosure is designed for generating a torque, the magnetic levitation device 1 is suitable for an electromagnetic rotary drive, which is designed as a temple motor. It is also possible that the magnetic levitation device 1 according to the disclosure is also suitable for other devices, such as centrifugal pumps, mixing devices for mixing flowable substances, stirring devices, for example for mixing a fluid in a tank, fans or also for devices for supporting and rotating wafers, for example in semiconductor production.

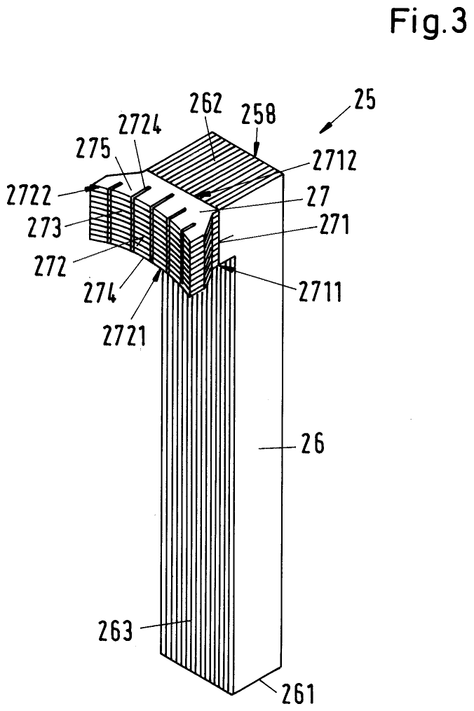

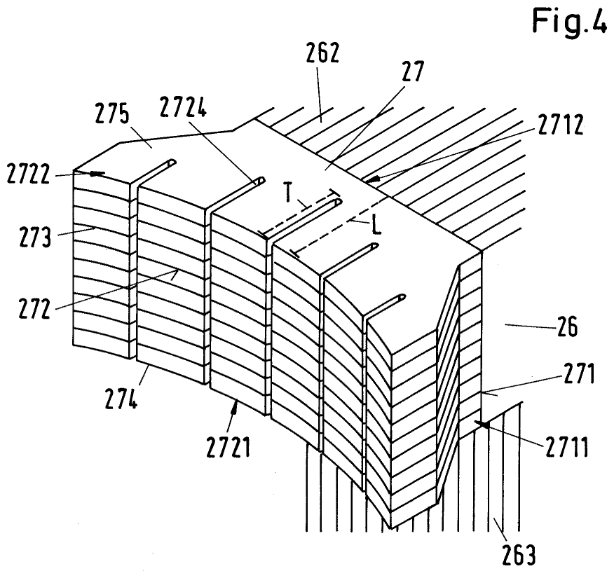

FIG. 3 shows a perspective view of a first variant of a coil core 25 from FIG. 2. One difference to the first variant is that the end face 272 has at least one slot 2724, wherein the at least one slot 2724 extends from an axially first end 274 of the pole piece 27 to an axially second end 275 of the pole piece 27. For better understanding, an enlarged view of the pole piece 27 of the coil core 25 from FIG. 3 is represented in FIG. 4.

The provision of at least one slot 2724 in the end face 272 of the coil core 25 provides an electrical insulation. This means that the at least one slot 2724 ensures that the path of the eddy currents in the transverse elements 273 of the pole piece 27 is interrupted and thus blocked. As a result, only small eddy currents remain in the coil core 25 and the eddy current losses in the coil core 25 are drastically reduced overall. Here, it is advantageous that the at least one slot 2724 should run parallel or at least approximately parallel to the course of the magnetic field in the transverse element 273 of the pole piece 27 so as not to block it.

A number of different methods can be used to produce the slots 2724. Inter alia, these include mechanical processes such as milling, punching or cutting, whereby the latter also includes the use of lasers and/or water jet cutters and/or wire erosion.

In this variant of the coil core 25, several slots 2724—here five slots 2724—are arranged parallel to one another in the end face 272. The number of slots 2724 in all embodiments and figures is to be understood purely as an example. The number can be larger or also smaller than represented. It is also possible that the slots 2724 can only be approximately parallel to one another, such as inclined or curved towards one another. Here, it is important that they follow the field course of the magnetic flux. This depends, inter alia, on the outer shape of the pole piece 27 or the transverse elements 273.

In this embodiment, an extension T of the slots 2724 in the radial direction R is smaller than the extension L of the pole piece 27 in the radial direction R.

In preferred variants, the extension T of the at least one slot 2724 in the radial direction R is in the area of 5-30% of the extension L of the pole piece 272 in the radial direction R. It is also possible that the extension T has more than 30%, e.g. 40% or 50% or even 99% of the extension L of the pole piece 27.

For the embodiment of a coil core 25 represented here, wherein the end face 272 is designed as a curved surface, it applies that the extension T is to be determined individually for each individual slot 2724, since the length L is different at each point on the edge 2722 due to the curvature. For this reason, the slots 2724 in this variant of the coil core 25 have different extensions T compared to each other.

Variants of the coil core 25 are also possible in which the slots 2724 all have the same extension T. This can be the case for coil cores 25 with a curved end face 272 as well as for coil cores 25 with a non-curved end face 272, as in the variant of the coil core 25 in FIG. 2. Of course, it is also possible that the slots 2724 can have different extensions T in the case of non-curved end faces 272.

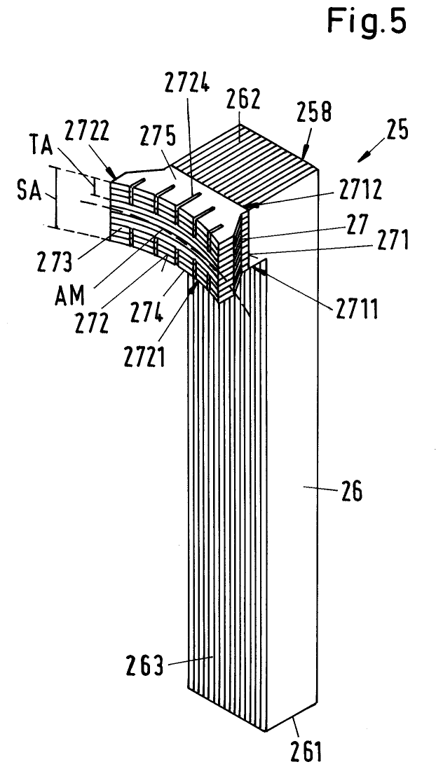

FIG. 5 shows a perspective view of a second variant of a coil core 25 from FIG. 2. In the following description of the second variant of a coil core, only the differences to the first variant from FIG. 3/4 are explained in more detail. The explanations of the first variant also apply in the same way or analogously to the second variant. The same reference signs designate the same features that were explained with reference to the first variant or features equivalent in function.

The second variant of a coil core 25 has slots 2724 in the end face 272, which extend in the axial direction A but do not extend through all the transverse elements 273. A first number of slots 2724 extends from the axially first end 274 of the pole piece 27 in the axial direction A and a second number of slots 2724 extends from the axially second end 275 of the pole piece 27 in the axial direction A opposite to the first number of slots 2724. In this case, the amount of each extension TA of all slots 2724 in the axial direction A is in each case less than 50% of the extension SA of the end face 272 in the axial direction A. In other words, this means that the end face 272 has a first number of slots 2724 that start at the axially first end 274 and a second number of slots 2724 that start at the axially second end 275, so that the first number and second number of slots 2724 do not touch each other in the axial center AM of the end face 272 and thus there is at least one transverse element 273 of the pole piece 27 which is not captured by the slots 2724.

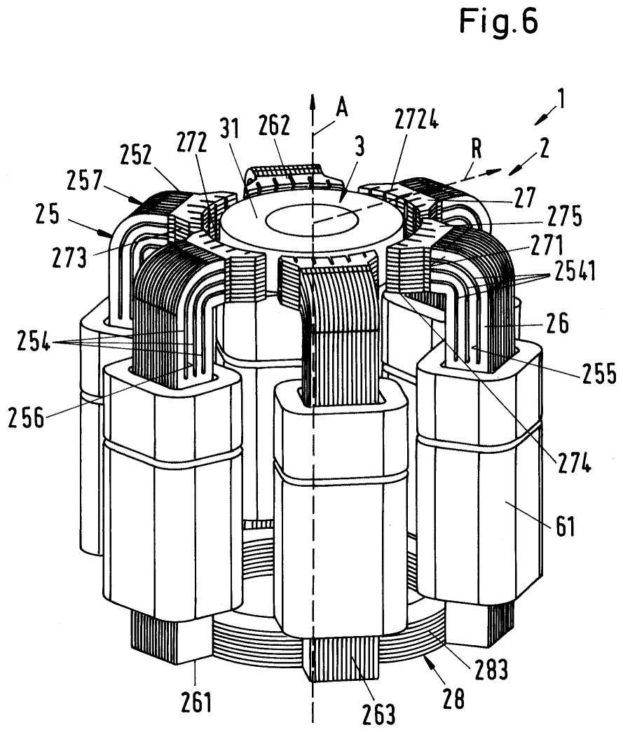

In this variant, extensions T of the at least one slot 2724 in the radial direction are possible, which are even equal to the extension L of the pole piece 27 in the radial direction R. FIG. 6 shows a perspective view of a second embodiment of a magnetic levitation device 1 according to the disclosure. For better understanding, a perspective view of an individual coil core 25 of the magnetic levitation device 1 from FIG. 6 is represented in FIG. 7. In the following description of the second embodiment of the magnetic levitation device 1, only the differences to the first embodiment from FIG. 1 are explained in more detail. The explanations of the first embodiment also apply in the same way or analogously to the second embodiment. The same reference signs designate the same features that were explained with reference to the first embodiment or features equivalent in function.

One difference is that each coil core 25 has a rounding off 257 at an axially upper end 252, which redirects the coil core from the axial direction A to the radial direction R.

For example, in the case of an L-shaped coil core 25, wherein the long part of the “L” is formed by the longitudinal leg 26 and the short part of the “L” by the pole piece 27, the radially outside located edge 258 (FIG. 1-Fig. 3) of the pole piece 27, when viewed from the cup-shaped recess 211, which extends in the radial plane in the circumferential direction is designed in a rounded manner. This embodiment has the advantage that it has lower eddy current losses and is also easier to realize with regard to construction. This embodiment can be realized with all possible embodiments of the end face 272 and the pole pieces 27 or longitudinal legs 26.

Each coil core 25 has a first lateral boundary surface 255 and a second lateral boundary surface 256, wherein at least one of the first or the second lateral boundary surfaces 255, 256 has at least one slot 254. In this embodiment, three slots 254 are arranged in each case both in the first and the second lateral boundary surfaces 255, 256. The slots 254 extend in the longitudinal leg 26. The provision of the slots 254 in the two lateral boundary surfaces 255, 256 of the coil core 25 provides an electrical insulation. This means that the slots 254 ensure that the path of the eddy currents in the coil core 25 is interrupted and thus blocked. As a result, only small eddy currents remain in the coil core 25 and the eddy current losses in the coil core 25 are drastically reduced overall.

In this embodiment, each of the slots 254 has a rounding 2541 which redirects the respective slot 254 from the radial direction R to the axial direction A. The slots 254 are arranged parallel to each other and parallel or at least approximately parallel to the course of the magnetic field in the coil core 25. This has the advantage that the slots 254 thus do not obstruct and/or block the course of the magnetic field in the coil core 25.

In this embodiment, the extension of the slots 254, when viewed in the circumferential direction of the stator 2, is shorter than the distance of the first lateral boundary surface 255 from the second lateral boundary surface 256. In other words, the slots 254 do not penetrate all longitudinal elements 263 of the coil cores 25, but only a certain number.

This is advantageous because the majority of the eddy currents occur especially in the longitudinal elements 263, which are arranged directly on or close to the two lateral boundary surfaces 255, 256. Thus, the paths of the eddy currents in the coil core 25 are interrupted by the slots 254 where they occur most frequently. This ensures a significant reduction in eddy current losses. Furthermore, an incomplete penetration of the slots 254 through all longitudinal elements 263 of the coil core 25 is advantageous for the stability of the coil core 25.

However, embodiments are also possible in which the slots 254 extend from the first lateral boundary surface 255 to the second lateral boundary surface 256.

In this embodiment, the slots 254 do not extend over the entire extension of the longitudinal leg 26 in the axial direction A, but only in part and end before an axially upper end of the concentrated winding 61a.

Furthermore, however, embodiments are also possible in which the at least one slot 254 has a longer extension in the longitudinal leg 26 than in the embodiment represented in FIG. 7. Such a possible embodiment is represented in FIG. 8.

FIG. 8 shows a perspective view of a third embodiment of a magnetic levitation device 1 according to the disclosure. In the following description of the third embodiment of the magnetic levitation device 1, only the differences to the first and second embodiment from FIG. 1 and FIG. 6 are explained in more detail. The explanations of the first and second embodiment also apply in the same way or analogously to the third embodiment. The same reference signs designate the same features that were explained with reference to the first embodiment or features equivalent in function.

As already mentioned, one difference of the third embodiment is the extension of the slots 254 in the longitudinal leg 26. This is significantly longer than the extension of the slots 254 of the coil cores 25 from the second embodiment. The maximum possible extension of the slots 254 in the longitudinal leg 26 ends at the first end 261 of the longitudinal leg 26. Thus, it is possible that the slots 254 can have any extension lengths in the longitudinal leg 26.

A further difference of this embodiment of a magnetic levitation device 1 to the embodiments from FIG. 1 and FIG. 6 is that the back iron 28 is designed differently. The back iron 28 is designed in a ring-shaped manner with a metallic strip 29, which extends from a radially inner beginning 291 to a radially outer end 292. The strip 29 forms several strip windings 293, which lie flat against each other with respect to the radial direction R. The longitudinal legs 26 are delimited at the first end 261 by an axial end face 265, against which the back iron 28 rests. The back iron 28 forms a circular ring, the radial width of which is equal to the radial width of the end faces 265 of the longitudinal legs 26. This means that the radially inner beginning 291 is flush in the axial direction A with a radially inside located inner surface 266 of the longitudinal leg 26 and the radially outer end 292 is flush in the axial direction A with a radially outside located outer surface 267 of the longitudinal leg 26.

Inter alia, this has the advantage that there is more space inside the stator 2, which can be used to install other components in it. In doing so, the stator 2 together with the stator housing can be made smaller and more compact, which increases the flexibility of use of the magnetic levitation device 1.

A further advantage of such an arrangement of the back iron 28 results from the arrangement of the strip windings 293 of the strip 29 of the tape wound toroidal core. Due to the fact that the strip windings 293 are arranged perpendicular on the radial direction R, they have an orientation that is parallel to the magnetic field course in the longitudinal legs 26. As a result, the magnetic field from the longitudinal legs 26 enters the back iron 28 in the axial direction A and thus parallel to the strip windings 293. This means that the magnetic field does not penetrate any of the strip windings 293 in the radial direction R, whereby eddy current losses are avoided.

Likewise, as already mentioned, here only one concentrated winding 61 is arranged in each case at each longitudinal leg 26 in the third embodiment.

Needless to say, that all embodiments with their respective characteristics shown in the descriptions of the figures can be combined with each other in any way.

Furthermore, it is possible that all of the shown embodiments of a coil core 25 can be designed in such a way that the space available for the rotor 3 in the magnetic levitation device 1 is increased. This is achieved by a special external shape of the coil cores 25.

In the process, the coil core 25 is divided into an axially lower section and an axially upper section, wherein the lower section and the upper section are arranged adjacent to each other with respect to the axial direction A. The pole piece 27 is arranged at the axially upper section. For each coil core 25, the end face 272 of the pole piece 27 has a first distance in the radial direction from the axially lower section of the associated longitudinal leg 26, and a second distance in the radial direction from the axially upper section, wherein the second distance is greater than the first distance. This means that each longitudinal leg 26 is designed in such a way that the axially upper section is displaced outwards in the radial direction with respect to the axially lower section, so that the space available for the rotor 3 between the end faces 272 is increased without the risk of a direct transfer of the magnetic flux between the longitudinal leg 26 and the magnetically effective core 31 of the rotor 3 existing. Due to the fact that the axially upper sections are offset radially outwards with respect to the radial direction and relative to the axially lower sections, the distance, namely the second distance, between the longitudinal legs 26 and the end faces 272 increases in the area of the axially upper sections. In doing so, the distance between the magnetically effective core 31 of the rotor and the longitudinal legs 26, particularly in the area of the axially upper sections, also increases.

Such coil cores 25 just described are designed analogously to those coil cores illustrated in FIG. 3 in the European patent application EP4084304A1.

FIG. 9 shows a schematic sectional view for an embodiment of a stator housing 21. In the embodiments in FIG. 1, FIG. 6 and FIG. 8, this stator housing 21 is not represented for reasons of a better overview. FIG. 9 is only intended to serve as an illustration to show how an encapsulation of the interior of the stator 2 necessary for the operation of the magnetic levitation device 1 looks. For this reason, the other components of the stator 2 are only represented schematically and are to be understood as purely illustrative.

Embodiments of the stator housing 21 are also possible in which the cup-shaped recess 211 merges into a bore that extends centrally along the central axis of the stator 2 in the axial direction A through the entire stator housing 21.

During operation of the magnetic levitation device 1 in fields in which, for example, chemically aggressive substances are used, it is important that the interior of the stator 2 is securely encapsulated and thus protected from these substances. To ensure that a rotor 3 can still be used, the stator housing 21 has a cup-shaped recess 211 into which the rotor 3 can be inserted.

What is claimed is:

1. A magnetic levitation device for contactless magnetic levitation of a rotor, which has a disk-shaped or ring-shaped magnetically effective core, comprising:
a stator with a cup-shaped recess arranged at an axial end of the stator and into which the rotor is capable of being inserted, the stator having a plurality of coil cores, each of the plurality of coils having a longitudinal leg and a pole piece, for each of the plurality of coils the longitudinal leg extends from a first end in an axial direction to a second end, and a contact surface is arranged at the second end, and each pole piece extends from the contact surface at least partially in a radial direction to an end face, the radial direction being perpendicular to the axial direction, the end faces of the plurality of coils arranged around the cup-shaped recess, and at least one concentrated winding is arranged at each longitudinal leg, the at least one concentrated winding surrounding a respective longitudinal leg, and
for each of the plurality of coils, the pole piece is made of transverse elements in sheet metal, the transverse elements stacked in the axial direction.

2. The magnetic levitation device according to claim 1, wherein for each of the plurality of coils, the longitudinal leg is made of longitudinal sheet metal elements, and the longitudinal sheet metal elements are stacked in a circumferential direction of the stator.

3. The magnetic levitation device according to claim 1, wherein the transverse elements or the longitudinal sheet metal elements are made of electrical sheet metal.

4. The magnetic levitation device according to claim 1, wherein for each of the plurality of coils, the contact surface is planar and is arranged at a surface of the longitudinal leg which is perpendicular to the radial direction.

5. The magnetic levitation device according to claim 1, wherein for each of the plurality of coils, the end face of the pole piece is a curved surface and the end face is arranged coaxially to the cup-shaped recess.

6. The magnetic levitation device according to claim 1, wherein for each of the plurality of coils, the end face is wider with respect to a circumferential direction than a maximum extension of the contact surface in the circumferential direction.

7. The magnetic levitation device according to claim 1, wherein for each of the plurality of coils, the end face has at least one slot which extends in the axial direction.

8. The magnetic levitation device according to claim 7, wherein the at least one slot extends from an axially first end of the pole piece to an axially second end of the pole piece.

9. The magnetic levitation device according to claim 8, wherein an extension of the at least one slot in the radial direction is shorter than an extension of the pole piece in the radial direction.

10. The magnetic levitation device according to claim 9, wherein the at least one slot is one of several slots arranged parallel or at least approximately parallel to each other in the end face.

11. The magnetic levitation device according to claim 1, wherein each coil core of the plurality of coil cores has a rounding at an axially upper end redirecting the coil core from the axial direction to the radial direction.

12. The magnetic levitation device according to claim 1, wherein each coil core of the plurality of coil cores has a first lateral boundary surface and a second lateral boundary surface, and at least one of the first or the second lateral boundary surfaces has at least one slot.

13. The magnetic levitation device according to claim 1, wherein a back iron is arranged at the first end of each of the longitudinal legs of the plurality of coil cords and connects the first ends of all longitudinal legs of the plurality of coil cords, the back iron is ring-shaped with a metallic strip extending from a radially inner beginning to a radially outer end, and the strip forms several strip windings which lie flat against one another with respect to the radial direction.

14. The magnetic levitation device according to claim 1, wherein the rotor is capable of being driven magnetically without contact for rotation about the axial direction by a torque generated by the stator.

15. An electromagnetic rotary drive, which is a temple motor, the electromagnetic rotary drive comprising:
a magnetic levitation device according to claim 14; and
the rotor with the disk-shaped or ring-shaped magnetically effective core, the rotor configured to be inserted into the cup-shaped recess, and is the rotor of the electromagnetic rotary drive.
